(19) United States
(12) Patent Application Publication
(10) Pub. No.: US 2008/0168483 A1
(43) Pub. Date: Jul. 10, 2008

(54) Shock-absorbing mobile hard disk mounting arrangement for mobile hard disk box

(76) Inventor: Wilson Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/649,252

(22) Filed: Jan. 4, 2007

(51) Int. Cl. G11B 33/08

(52) U.S. Cl. 720/651

(57) ABSTRACT

A shock-absorbing mobile hard disk mounting arrangement in which shock-absorbing spring members are provided to support the hard disk on the circuit board inside the mobile hard disk box, preventing damage to the hard disk when the mobile hard disk box is vibrated accidentally.

### BACKGROUND OF THE INVENTION

1. Field of the Invention

The present invention relates to a mobile hard disk box and more particularly, to a shock-absorbing mobile hard disk box mounting arrangement, which has shock-absorbing springs mounted on the four mounting through holes of the circuit board to support the hard disk after connection of the contact pins of the hard disk to the electric socket of the circuit board, thereby preventing damage to the hard disk upon an accidental vibration.

2. Description of the Related Art

FIG. 1 is a schematic exploded view of a hard disk and a circuit board for mounting in a mobile hard disk box according to the prior art. The hard disk, referenced by 10, can be a 2.5″ or 1.8″ hard disk. The hard disk 10 has contact pins 11 at one side for connection to a socket 21 at a circuit board 20 (see FIG. 2). After connection of the hard disk 10 to the circuit board 20, the hard disk 10 and the circuit board 20 are mounted in a mobile hard disk box.

The aforesaid hard disk mounting arrangement is still not satisfactory in function because of the following drawbacks:

1. The hard disk 10 is directly supported on the circuit board 20 after connection of the contact pins 11 to the socket 21. Because the mobile hard disk box has no means to absorb shocks, the hard disk 10 tends to be vibrated accidentally by an external force. Vibration of the hard disk 10 during its operation will result in data access instability.

2. The hard disk 10 is directly supported on the top side of the circuit board with its contact pins 11 horizontally connected to the socket 21 of the circuit board 20. This mounting arrangement cannot protect the hard disk 10 against shocks, and an accidental vibration of the mobile hard disk box may cause damage to the hard disk 10.

### SUMMARY OF THE INVENTION

The present invention has been accomplished under the circumstances in view. It is the main object of the present invention to provide a shock-absorbing mobile hard disk mounting arrangement, which absorbs shocks upon an accidental vibration of the mobile hard disk box during operation of the hard disk, preventing damage to the hard disk. It is another object of the present invention to provide a shock-absorbing mobile hard disk mounting arrangement, which assures high data access stability during operation of the hard disk.

To achieve this and other objects of the present invention, the shock-absorbing mobile hard disk mounting arrangement comprises a circuit board, which has an electric socket, a hard disk, which is mounted on the circuit board and has a set of contact pins connected to the electric socket of the circuit board, and a plurality of spring members installed in the circuit board to support the hard disk on the top side of the circuit board for absorbing shocks.

### BRIEF DESCRIPTION OF THE DRAWINGS

FIG. 1 is a schematic exploded view of a hard disk and a circuit board for mounting in a mobile hard disk box according to the prior art.

FIG. 2 is an assembly view of FIG. 1.

FIG. 3 is a schematic exploded view of a hard disk and a circuit board for mounting in a mobile hard disk box according to the present invention.

FIG. 4 is an assembly view of FIG. 3.

FIG. 5 is a side view of FIG. 4.

FIG. 6 is an exploded view of a mobile hard disk box according to the present invention.

FIG. 7 is an elevational assembly view of FIG. 6.

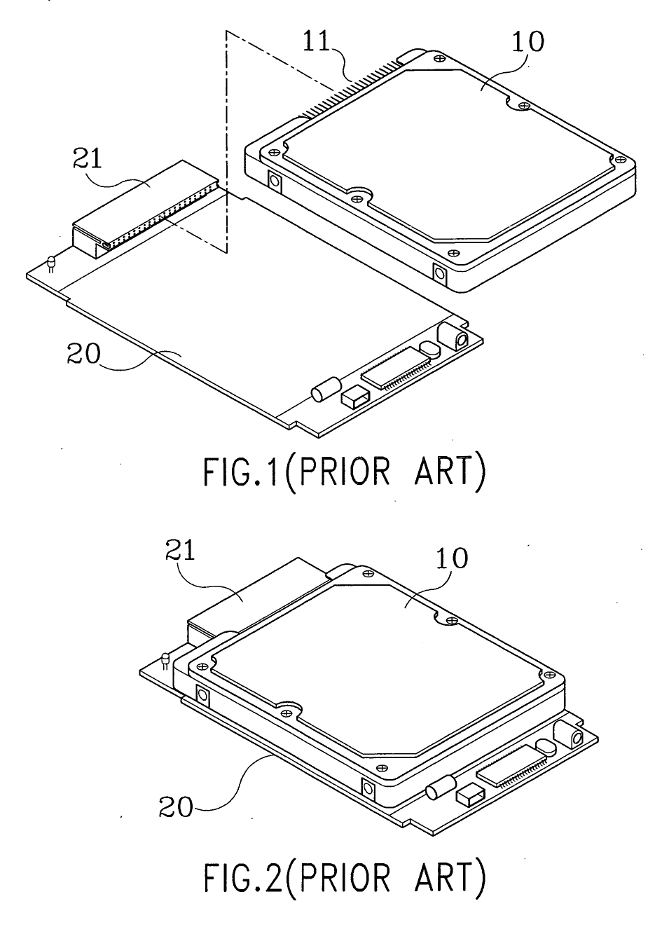

### DETAILED DESCRIPTION OF THE PREFERRED EMBODIMENT

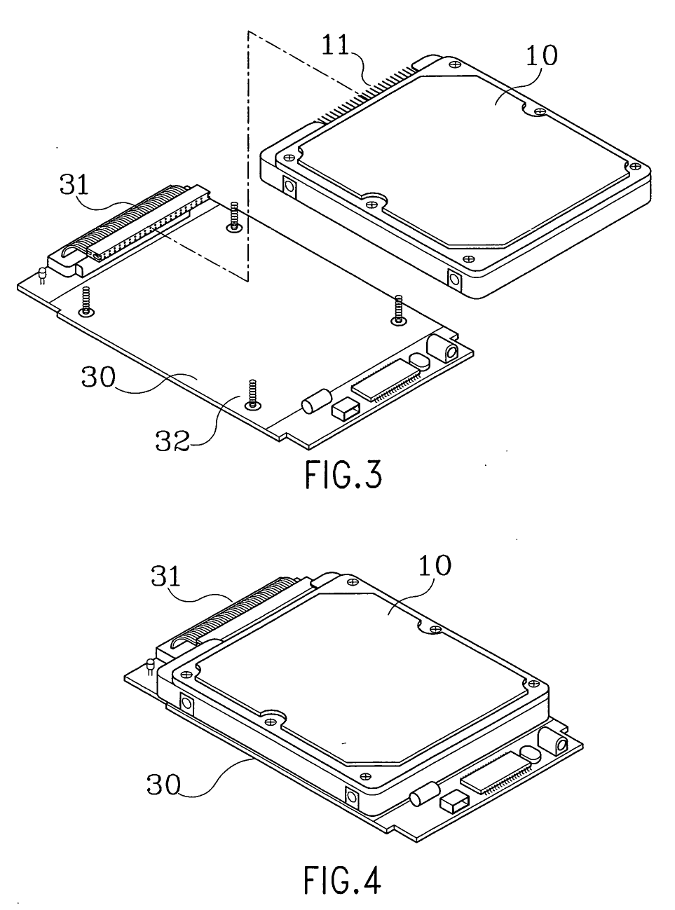

Referring to FIGS. 3˜5, a hard disk 10 is mounted on a circuit board 30. The circuit board 30 has an electric socket 31 horizontally mounted on its top wall near one side, a plurality of mounting through holes (not shown), and a plurality of shock-absorbing spring members 32 respectively mounted on the top wall corresponding to the mounting through holes. The hard disk 10 is supported on the shock-absorbing spring members 32 above the circuit board 30 and vertically movably connected to the mounting through holes of the circuit board 30 with screws (not shown), having a set of contact pins 11 connected to the electric socket 31 of the circuit board 30. After installation, the shock-absorbing spring members 32 can absorb shocks when an external force vibrates the circuit board 30 accidentally.

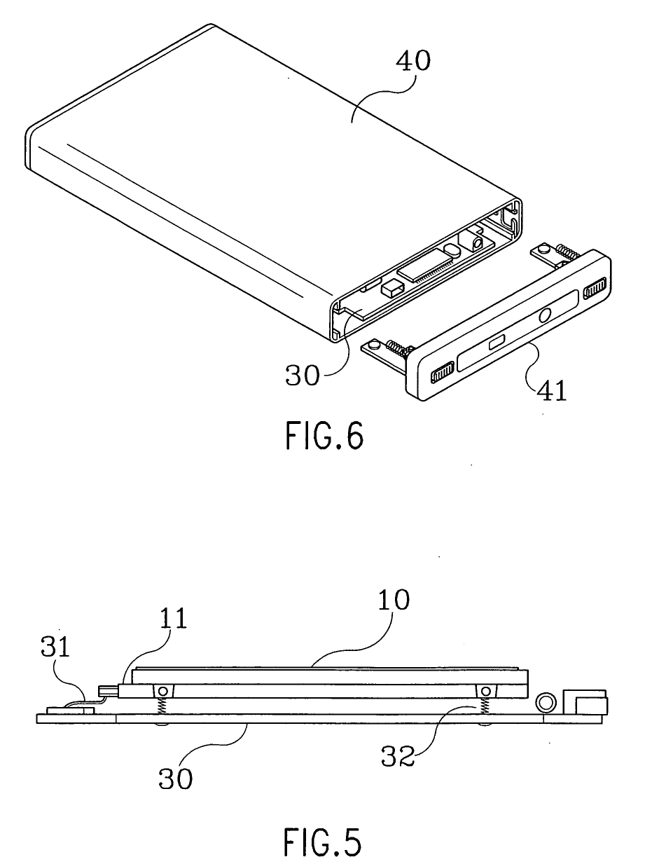

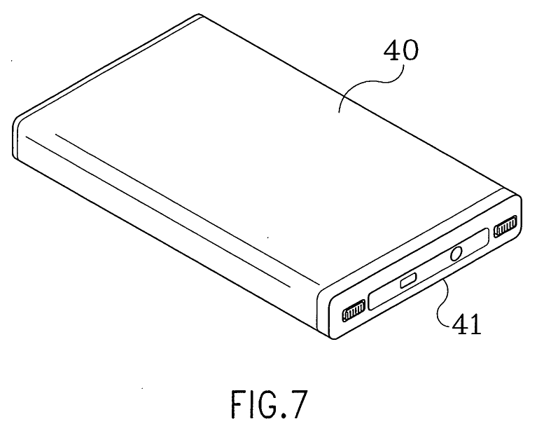

Referring to FIGS. 6 and 7 and FIGS. 3 through 5 again, when assembled, assembly of the circuit board 30 and the hard disk 10 is mounted in a mobile hard disk box 40, and then a front cover 41 is covered on the front side of the mobile hard disk box 40. In case the mobile hard disk box 40 is vibrated accidentally during operation of the hard disk 10, the shock-absorbing spring members 32 absorb shocks, preventing damage to the hard disk 10.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A mobile hard disk box comprising a circuit board, said circuit board having an electric socket, a hard disk mounted on said circuit board, said hard disk having a set of contact pins electrically connected to the electric socket of said circuit board, and a plurality of spring members mounted on said circuit board in four corners to support said hard disk on said circuit board for absorbing shocks.
